(19) United States
(12) Patent Application Publication
(10) Pub. No.: US 2026/0108127 A1
(43) Pub. Date: Apr. 23, 2026

(54) SYSTEMS AND METHODS FOR DISHMACHINE SMART HEATER

(71) Applicant: Ecolab USA Inc., Saint Paul, MN (US)

(72) Inventor: Jared Patrick Weldon, High Point, NC (US)

(21) Appl. No.: 19/359,135

(22) Filed: Oct. 15, 2025

Related U.S. Application Data
(60) Provisional application No. 63/708,448, filed on Oct. 17, 2024.

(51) Int. Cl. A47L 15/00; A47L 15/42; G01M 99/00

(52) U.S. Cl. CPC A47L 15/0049; A47L 15/0063; A47L 15/0081; A47L 15/4285; G01M 99/005; A47L 2401/30; A47L 2401/34; A47L 2501/26

(57) ABSTRACT

Various examples are directed to systems and methods for a smart heater for a dishwasher. A method includes monitoring, using a proportional, integral, and derivative (PID) controller, a dishwasher during operation of the dishwasher, and detecting, using the PID controller, an error condition of the dishwasher using signals from one or more sensors. The method also includes reporting, using a communication transceiver, failure information of the error condition, and diagnosing, using the failure information and machine learning, a heating element component failure of the dishwasher. The method further includes generating, based on the diagnosed component failure, service instructions for the component failure of the dishwasher, and displaying, for a user of the dishwasher, the service instructions including identifying information of replacement components for the dishwasher.

### CLAIM OF PRIORITY AND INCORPORATION BY REFERENCE

The present application claims the benefit under 35 U.S.C. § 119(e) of U.S. Provisional Patent Application 63/708,448, filed Oct. 17, 2024, the disclosure of which is hereby incorporated by reference herein in its entirety.

### TECHNICAL FIELD

This application relates generally to washing machines and more particularly to systems and methods for a smart heater in a washing machine such as a dishwasher.

### BACKGROUND

A dishwasher, also referred to as a dishmachine, warewasher or warewashing machine, is a machine for automatically cleaning articles, such as dishes, trays, laboratory equipment, dinnerware, and kitchenware. A common domestic dishwasher is an undercounter unit intended to be installed under a kitchen counter. Other types of dishwashers include industrial or commercial dishwashers for use in restaurants, hotels, and other commercial establishments with food services.

Common commercial dishwashers include one or more heating elements used to increase water temperature to properly wash and/or rinse dishes. A faulty heating element may interrupt or interfere with proper operation of the dish machines. In commercial settings, dishwasher service interruptions can have a large detrimental impact on the businesses and establishments that use the machines.

What is needed is an improved heater monitoring and reporting system for dishwashers that provides for shorter machine down times and more efficient machine operation.

### SUMMARY

A system and method for a smart heater for dishwashers is provided. A method includes monitoring, using a proportional, integral, and derivative (PID) controller, a dishwasher during operation of the dishwasher, and detecting, using the PID controller, an error condition of the dishwasher using signals from one or more sensors. The method also includes reporting, using a communication transceiver, failure information of the error condition, and diagnosing, using the failure information and machine learning, a heating element component failure of the dishwasher. The method further includes generating, based on the diagnosed component failure, service instructions for the component failure of the dishwasher, and displaying, for a user of the dishwasher, the service instructions including identifying information of replacement components for the dishwasher.

Various examples, include a system for a smart heater for dishwashers. The system includes a computing system comprising one or more processors and a data storage system in communication with the one or more processors, wherein the data storage system comprises instructions thereon that, when executed by the one or more processors, causes the one or more processors to: monitor, using a proportional, integral, and derivative (PID) controller, a dishwasher during operation of the dishwasher, detect, using the PID controller, an error condition of the dishwasher using signals from one or more sensors, report, using a communication transceiver, failure information of the error condition, diagnose, using the failure information and machine learning, a heating element component failure of the dishwasher, generate, based on the diagnosed component failure, service instructions for the component failure of the dishwasher, and display, for a user of the dishwasher, the service instructions including identifying information of replacement components for the dishwasher.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

1The drawings illustrate generally, by way of example, various embodiments discussed in the present document. The drawings are for illustrative purposes only and may not be to scale.

FIG. 1A illustrates a block diagram of a system including a smart heater for a dishwasher, according to various embodiments.

FIGS. 1B-1D illustrate perspective views of a dishwasher, according to various embodiments.

FIGS. 1E-1F illustrate graphical displays of the present system for a smart heater for a dishwasher, according to various embodiments.

FIG. 2 illustrates a flowchart of a method for a smart heater for a dishwasher, according to various embodiments.

FIG. 3 illustrates an example machine learning module for a smart heater for a dishwasher, according to various embodiments.

FIG. 4 illustrates a flowchart of a method of training a model for a smart heater for a dishwasher, according to various embodiments.

FIG. 5 is a block diagram of a machine in the example form of a computer system within which a set of instructions may be executed, for causing the machine to perform any one or more of the methodologies discussed herein.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The scope of the present invention is defined by the appended claims, along with the full scope of legal equivalents to which such claims are entitled.

Common commercial dishwashers include one or more heating elements used to increase water temperature to properly wash and/or rinse dishes. A faulty heating element may interrupt or interfere with proper operation of the dish machines. In commercial settings, dishwasher service interruptions can have a large detrimental impact on the businesses and establishments that use the machines.

The present subject matter provides an improved heater monitoring and reporting system for dishwashers that provides for shorter machine down times and more efficient machine operation. The system uses a PID controller to monitor the heating element and report issues, and further leverages machine learning to monitor, diagnose, and provide remedies for dishwasher heating element maintenance and performance. The system reports failures to a user, either remotely using a cellular connected gateway or locally using a connection such as Bluetooth to a mobile phone application, in some examples.

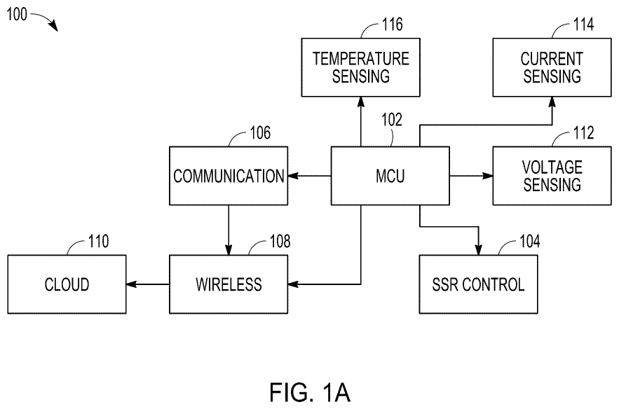

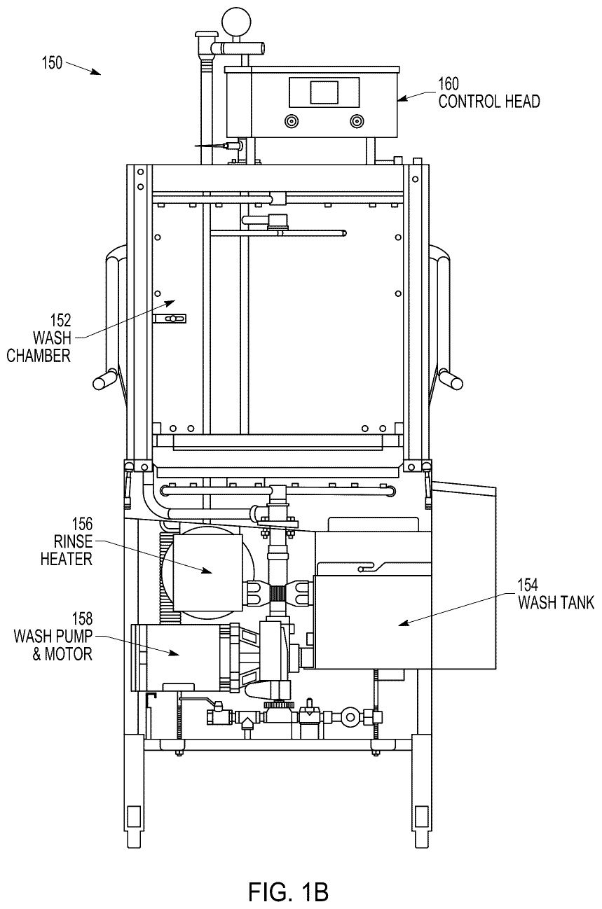

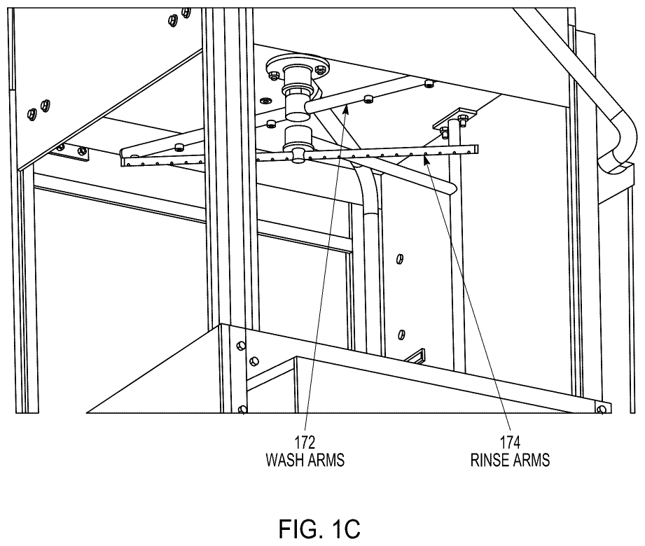

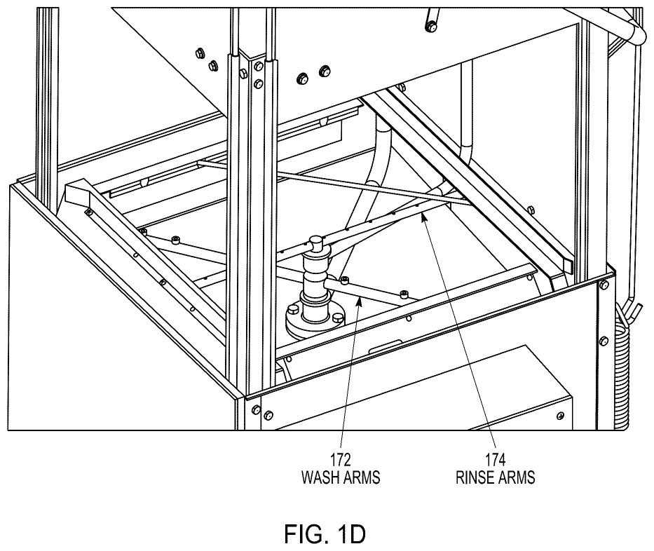

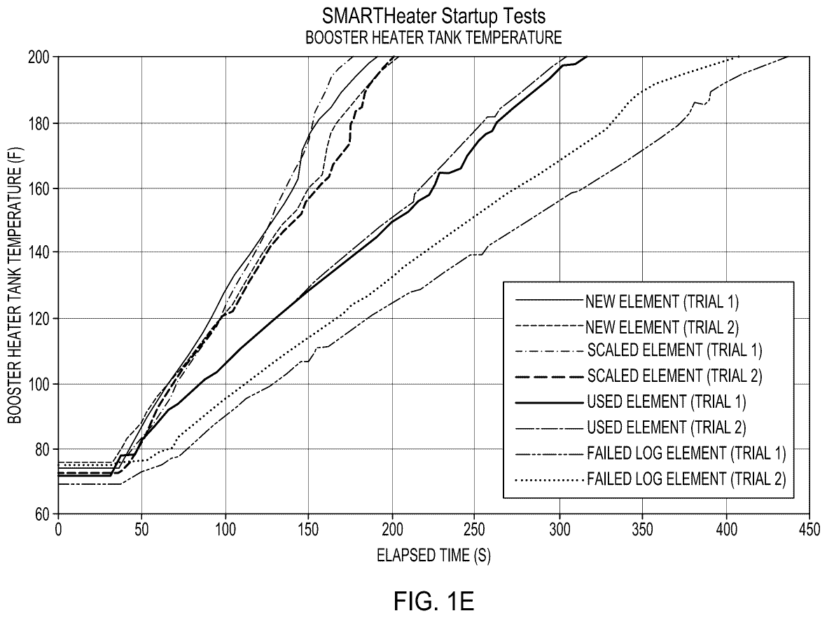

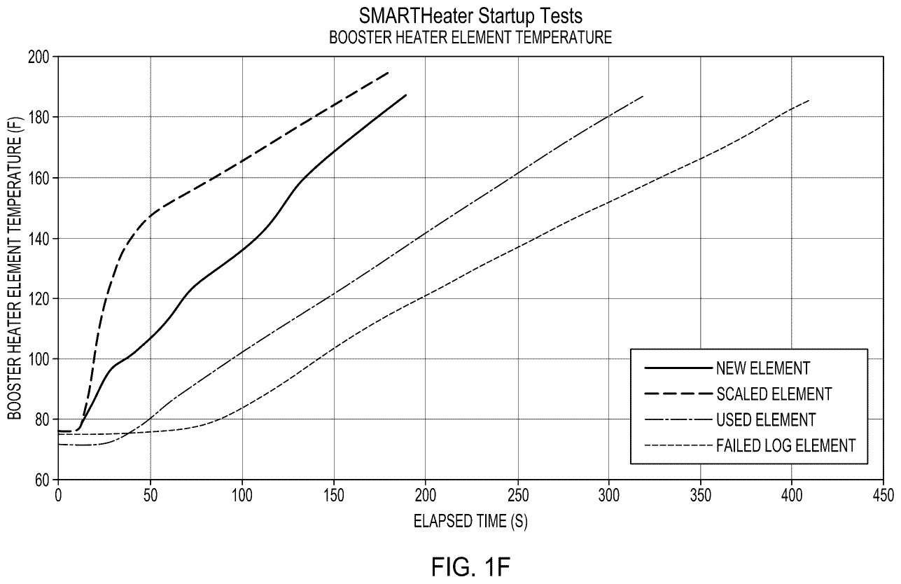

FIG. 1A illustrates a block diagram of a system 100 including a smart heater for a dishwasher, according to various embodiments. The system 100 includes a computing system comprising one or more processors and a data storage system in communication with the one or more processors, wherein the data storage system comprises instructions thereon that, when executed by the one or more processors, causes the one or more processors to: monitor, using a proportional, integral, and derivative (PID) controller, a dishwasher during operation of the dishwasher, detect, using the PID controller, an error condition of the dishwasher using signals from one or more sensors, report, using a communication transceiver, failure information of the error condition, diagnose, using the failure information and machine learning, a component failure of the dishwasher, generate, based on the diagnosed component failure, service instructions for the component failure of the dishwasher, and display, for a user of the dishwasher, the service instructions including identifying information of replacement components for the dishwasher.

In various embodiments, the one or more processors include a microcontroller unit (MCU) 102. In various embodiments, the PID controller includes the MCU 102 and a solid-state relay (SSR) control 104. The SSR control 104 is an electronic switch that changes state based on a change in voltage across its terminals, in one example. In various embodiments, the MCU 102 communicates with the one or more sensors, which may include voltage sensing 112, current sensing 114 and temperature sensing 116. The MCU 102 may also interface with a communication circuit 106 and/or a wireless interface 108 that communicates with a cloud-based computing system 110, in various examples.

According to various embodiments, the one or more processors may include the MCU 102, a processor of a mobile device, and/or a processor of a cloud-based system 110. The wireless interface 108 may include a Bluetooth communication transceiver or a cellular communication transceiver, in some examples. In various embodiments, service instructions are wirelessly provided to a person or entity having a mobile device. Other data sources and modes of communicating the service instructions are possible without departing from the scope of the present subject matter.

If it is determined that a heating element component failure is likely, data may be sent either locally (e.g., using Bluetooth, ZigBee, Wi-Fi, LoRa, etc.) to a service associate, or to a central cellular gateway for further analysis and communication of activity to service associate. A number of wireless protocols may be used by the present device to communicate and report data to one or more external devices (such as a computer, a smartphone, a tablet, etc.), to other devices, to a router, to a gateway, or the like. The wireless standards that may be used by the present subject matter include, but are not limited to, one or more of the following: LoRa, near-field communication (NFC), Bluetooth, Bluetooth Low Energy (BLE), Ethernet, Wi-Fi, WiMax, ZigBee, or cellular standard communications such as 3G, 4G, LTE, 5G. Other wireless standards may be used without departing from the scope of the present subject matter.

In various embodiments, the present subject matter provides a machine health and temperature controller device that is used to control and monitor equipment. The device is capable of remote monitoring via a wireless or wired connection. The device can also be used to monitor more than one heater and in addition can monitor other components such as motors and other electrical devices, in various embodiments. The device, systems and methods use PID control with solid state actuation, providing energy sensing and leveraging machine learning to detect limescale and heating element degradation and failure.

In some examples machine monitoring is based on sensing limescale build up. In addition, current, voltage and temperature sensing technologies are used to monitor failures within the machine. In various examples, PID temperature and solid-state control are used detect limescale and monitor machine health to improve reliability of the machine. Thus, the device, systems and methods improve reliability and performance of heating circuits and monitor the dishwashing machine for potential issues.

The present system and method may be used to monitor other types of machines. In various examples, the present system and method may be used in water treatment, food and beverage, pool and spa, or any other machine where a temperature controller is being used. The machine health, such as detected using current and voltage sensing, can be used on any electrical equipment. The present system senses temperature, current and/or voltage and can use machine learning to predict failures or alert the user of malfunctions by sensing a parameter of the machine or the individual component, in various examples. In one example, sensor information is sent via a communication cable or wirelessly (including, but not limited to, one or more of Bluetooth, BLE, Cellular, LoRa, as some examples) and further analyzing can be done in the cloud, with results sent back to the controller to change machine operation, such as by changing a setpoint if a component failed.

In various examples, the present system provides a booster heating element lifetime model and analysis for dishwashing machines. For example, the present system directly monitors the performance and behavior of the heating element used in a rinse booster heater of a dishwashing machine.

In various embodiments, the present system predicts the current condition of heating elements by analyzing input power and heating time data for new, used, and scaled heating elements. The system creates a model predicting a reason for failure or potential upcoming failure of a heating element, such as a rinse booster heater of a dishmachine, to provide for troubleshooting and preventative maintenance in the field.

According to some examples, data is collected offline for model creation, and the model is used for prediction and analysis of field operation of the heating element or heating elements. Offline model creation may include use of various new and used heating elements, using various numbers of rinse cycles of varying durations, with varying times between cycles and varying amounts of rinse water, in some examples. One or more variables can be sensed, measured or monitored by the system. Examples include inlet temperature, interior booster heater temperature, input voltage to the heating element, input current through the heating element, inlet flow of water into the tank, and heating element temperature.

In addition, the system may perform a static water heating time test, to measure the time to heat full tank of static water from one set temperature to another set temperature. In this example the system may log instantaneous temperature in set intervals (e.g., one sample/sec), and the heating element is turned on during entirety of the test. The system may also or alternatively perform a cycling water heating time test, to measure the time to repeatedly reheat flowing water through tank. In this example, the system automatically opens and closes a solenoid valve to let in a constant duration (e.g., rinse cycle time) of water each cycle for a set number of cycles. The heating element automatically cycles on and off based on signal using a minimum and maximum temperature setpoint, in various examples. In some examples, the system measures temperature inside the tank and directly adjacent to the heating element. The system determines heating time when an amount of water in the tank is static, in one example. In various examples, the system tracks the time duration that the heating element has been running and how many times it has cycled on and off, by logging data received from one or more sensors. In some examples, the system measures output or rinse temperature, and predicts the booster heater temperature based on the correlation between the heater and rinse temperature. Additional data may be logged, in some embodiments, such as voltage, current, temperature and timestamps. Other data may be sensed and logged for the heating elements without departing from the scope of the present subject matter. New, used and scaled heating elements may be included when training the model, in various embodiments.

FIGS. 1B-1D illustrate perspective views of a dishwasher, according to various embodiments. FIG. 1B shows a dishmachine or dishwasher 150 having a wash changer 152, a wash tank 154, a wash pump and motor 158, and a rinse heater 156. In various embodiments, a control head 160 is affixed to or placed on top of the dishwasher 150 and used to control operation of the dishwasher 150. FIG. 1C shows a view of the dishwasher 150 showing upper wash arms 172 and rinse arms 174 used for circulating water to clean dishes in the dishwasher. FIG. 1D shows a view of the dishwasher 150 showing lower wash arms 172 and rinse arms 174.

FIGS. 1E-1F illustrate graphical displays of the present system for a smart heater for a dishwasher, according to various embodiments. FIG. 1E shows a measured booster heater tank temperature for a dishwashing machine, in various embodiments. The resulting plots illustrate the different tank temperatures sensed based on whether the machine is using a new heating element, a scale-covered heating element, a used heating element, and a failed leg element, in various examples. FIG. 1F shows a measured booster heater element temperature for a dishwashing machine, in various embodiments. The resulting plots illustrate the different element temperatures sensed based on whether the machine is using a new heating element, a scale-covered heating element, a used heating element, and a failed leg element, in various examples. The depicted plots show that the present subject matter can be used to detect and distinguish a normally functioning element, an element with limescale build up and a failed component. In some examples, as an amount of limescale on the heater element increased, the high limit sensor has a different temperature curve for the heater element temperature. In addition, voltage and current sensing may also be used to confirm proper function of the controller.

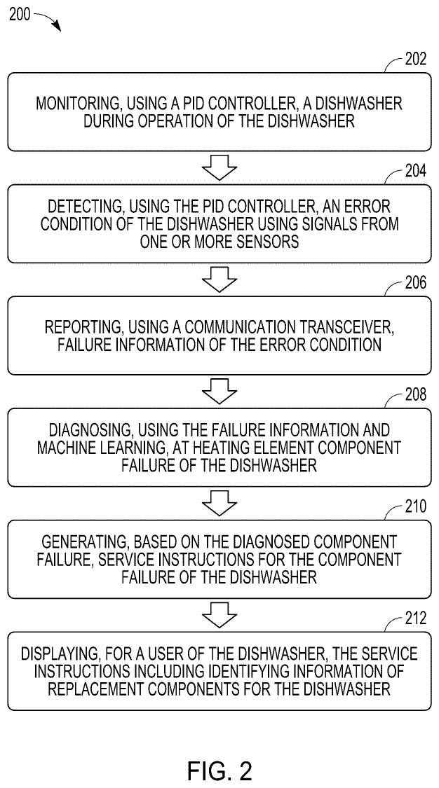

FIG. 2 illustrates a flowchart of a method for a smart heater for a dishwasher, according to various embodiments. The method 200 includes monitoring, using a proportional, integral, and derivative (PID) controller, a dishwasher during operation of the dishwasher, at step 202. At step 204, the method includes detecting, using the PID controller, an error condition of the dishwasher using signals from one or more sensors. The method 200 also includes reporting, using a communication transceiver, failure information of the error condition, at step 206, and diagnosing, using the failure information and machine learning, a heating element component failure of the dishwasher, at step 208. The method 200 further includes generating, based on the diagnosed component failure, service instructions for the component failure of the dishwasher, at step 210, and displaying, for a user of the dishwasher, the service instructions including identifying information of replacement components for the dishwasher, at step 212.

According to various embodiments, monitoring the dishwasher during operation of the dishwasher includes remotely monitoring the dishwasher. Remotely monitoring the dishwasher during operation of the dishwasher includes using a wireless or wired connection, in various examples. In one example, monitoring the dishwasher during operation of the dishwasher includes monitoring a heating element of the dishwasher. Monitoring the dishwasher during operation of the dishwasher includes sensing limescale build up on a component of the dishwasher, in an example. In various examples, monitoring the dishwasher during operation of the dishwasher includes sensing electrical current of the dishwasher, sensing electrical voltage of the dishwasher, and/or sensing temperature of the dishwasher. Reporting failure information of the error condition includes reporting failure information to a mobile device application and/or to a cloud-based system, in various embodiments.

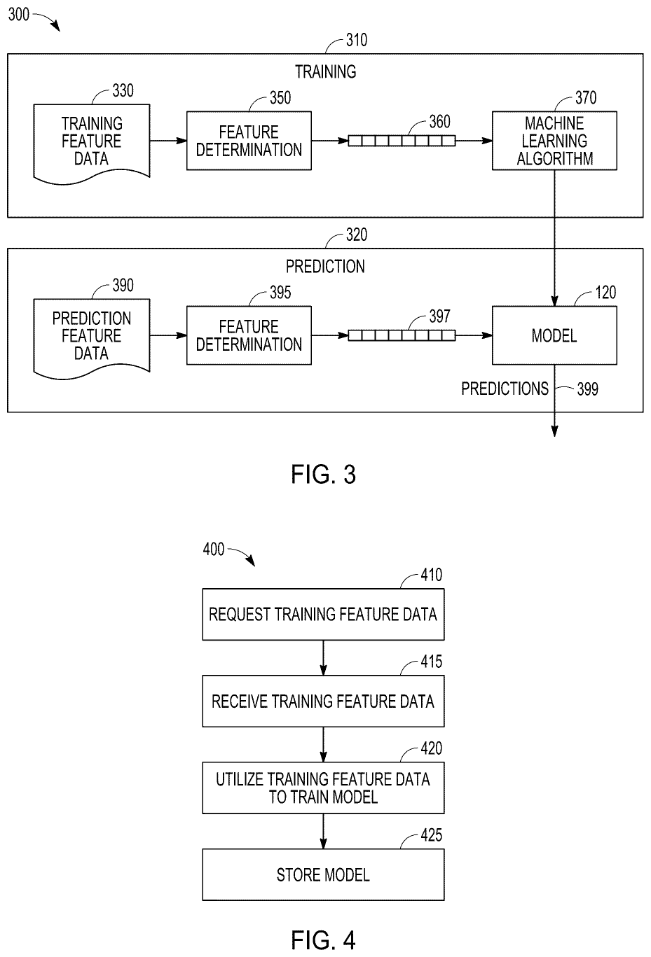

FIG. 3 shows an example machine learning module 300 according to some examples of the present disclosure. The machine learning module 300 may be implemented in whole or in part by one or more computing devices. In some examples, the training module 310 may be implemented by a different device than the prediction module 320. In these examples, the model 120 may be created on a first machine and then sent to a second machine.

Machine learning module 300 utilizes a training module 310 and a prediction module 320. Training module 310 inputs training feature data 330 into feature determination module 350. The training feature data 330 may include data determined to be predictive of performance of a smart heater for a dishwasher. Categories of training feature data may include tracked data, input data, image data, user data, other third-party data, or the like. Specific training feature data and prediction feature data 390 may include, for example one or more of: current tracked data, past tracked data, and the like.

Feature determination module 350 selects training vector 360 from the training feature data 330. The selected data may fill training vector 360 and comprises a set of the training feature data that is determined to be predictive of performance of a smart heater for a dishwasher. In some examples, the tasks performed by the feature determination module 350 may be performed by the machine learning algorithm 370 as part of the learning process.

Feature determination module 350 may remove one or more features that are not predictive of performance of a smart heater for a dishwasher to train the model 120. This may produce a more accurate model that may converge faster. Information chosen for inclusion in the training vector 360 may be all the training feature data 330 or in some examples, may be a subset of all the training feature data 330.

In other examples, the feature determination module 350 may perform one or more data standardization, cleanup, or other tasks such as encoding non numerical features. For example, for categorical feature data, the feature determination module 350 may convert these features to numbers. In some examples, encodings such as “One Hot Encoding” may be used to convert the categorical feature data to numbers. This enables a representation of the categorical variables as binary vectors and provided a “probability-like” number for each label value to give the model more expressive power. One hot encoding represents a category as a vector whereby each possible category value is represented by one element in the vector. When the data is equal to that category value, the value of the vector is a ‘1’ and all other elements are zero (or vice versa).

The training vector 360 may be utilized (along with any applicable labels) by the machine learning algorithm 370 to produce a model 120. In some examples, other data structures other than vectors may be used. The machine learning algorithm 370 may learn one or more layers of a model. Example layers may include convolutional layers, dropout layers, pooling/up sampling layers, SoftMax layers, and the like. Example models may be a neural network, where each layer is comprised of a plurality of neurons that take a plurality of inputs, weight the inputs, input the weighted inputs into an activation function to produce an output which may then be sent to another layer. Example activation functions may include a Rectified Linear Unit (ReLu), and the like. Layers of the model may be fully or partially connected. In other examples, machine learning algorithm may be a gradient boosted tree and the model may be one or more data structures that describe the resultant nodes, leaves, edges, and the like of the tree.

In the prediction module 320, prediction feature data 390 may be input to the feature determination module 395. The prediction feature data 390 may include the data described above for the training feature data, but for a specific item such as dishwasher heating element failure identification or classification. In some examples, the prediction module 320 may be run sequentially for one or more items. Feature determination module 395 may operate the same, or differently than feature determination module 350. In some examples, feature determination modules 350 and 395 are the same modules or different instances of the same module. Feature determination module 395 produces vector 397, which is input into the model 120 to produce predictions 399. For example, the weightings and/or network structure learned by the training module 310 may be executed on the vector 397 by applying vector 397 to a first layer of the model 120 to produce inputs to a second layer of the model 120, and so on until the prediction 399 is output. As previously noted, other data structures may be used other than a vector (e.g., a matrix).

The training module 310 may operate in an offline manner to train the model 120. The prediction module 320, however, may be designed to operate in an online manner. It should be noted that the model 120 may be periodically updated via additional training and/or user feedback. For example, additional training feature data 330 may be collected. The feedback, along with the prediction feature data 390 corresponding to that feedback, may be used to refine the model by the training module 310.

In some example embodiments, results obtained by the model 120 during operation (e.g., outputs produced by the model in response to inputs) are used to improve the training data, which is then used to generate a newer version of the model. Thus, a feedback loop is formed to use the results obtained by the model to improve the model.

The machine learning algorithm 370 may be selected from among many different potential supervised or unsupervised machine learning algorithms. Examples of learning algorithms include artificial neural networks, convolutional neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, gradient boosted tree, linear classifiers, quadratic classifiers, k-nearest neighbor, linear regression, logistic regression, a region based CNN, a full CNN (for semantic segmentation), a mask R-CNN algorithm for instance segmentation, and hidden Markov models. Examples of unsupervised learning algorithms include expectation-maximization algorithms, vector quantization, and information bottleneck method.

The machine learning may include a machine learning model including a neural network. The machine learning model may include one or more of a long short-term memory (LSTM) network, bidirectional encoder representations from transformers (BERT), natural language processing (NLP), or an artificial intelligence (AI)-based knowledge tree, in various examples. In various examples, the artificial intelligence includes a large language model (LLM). Other types of machine learning models may be used without departing from the scope of the present subject matter.

FIG. 4 illustrates a flowchart of a method of training a model for a smart heater for a dishwasher 400, according to various embodiments. At operation 410 the training module (e.g., training module 310 as implemented by a model system) may request training feature data, from one or more systems. At operation 415 the training module may receive the training feature data. The training feature data may be processed using more data standardization, cleanup, or other tasks such as encoding non numerical features (e.g., one hot encoding). At operation 420, the training model may use the training feature data to train the model. For example, by creating a gradient boosted tree, neural network, or the like. At operation 425 the model may be stored in a storage device. In some examples in which the training operations and predictions are done on separate computing devices, the model may be transmitted to a computing device doing predictions. In various examples, the model may be used for a smart heater for a dishwasher.

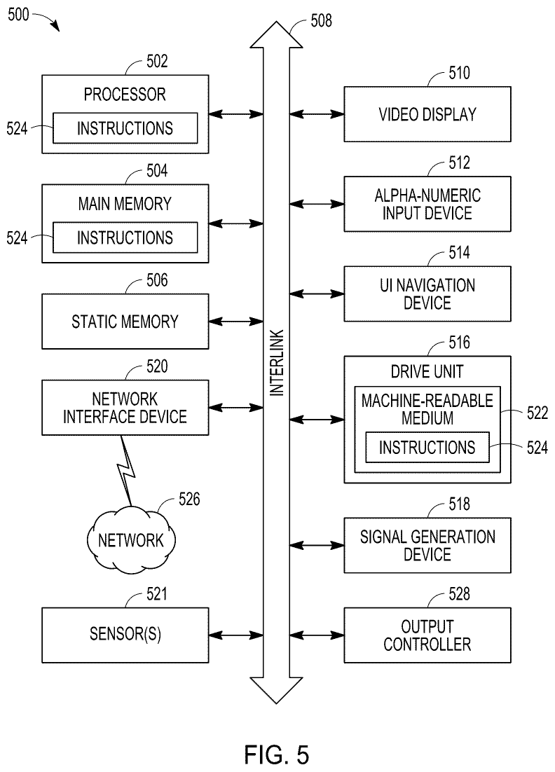

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be configured to perform the method of FIG. 4. The machine 500 may be in the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The processor 502 may be a digital signal processor (DSP), microprocessor, microcontroller, application-specific integrated circuit (ASIC), field-programmable gate array (FPGA), combinational logic, other digital logic, or combinations thereof. The processing may be done by a single processor, or may be distributed over different devices. The processing of signals referenced in this application may be performed using the processor or over different devices. Processing may be done in the digital domain, the analog domain, or combinations thereof. Processing may be done using subband processing techniques. Processing may be done using frequency domain or time domain approaches. Some processing may involve both frequency and time domain aspects. For brevity, in some examples, drawings may omit certain blocks that perform frequency synthesis, frequency analysis, analog-to-digital conversion, digital-to-analog conversion, signal transmission, amplification, buffering, and certain types of filtering and processing. In various examples of the present subject matter the processor is adapted to perform instructions stored in one or more memories, which may or may not be explicitly shown. Various types of memory may be used, including volatile and nonvolatile forms of memory. In various examples, the processor or other processing devices execute instructions to perform a number of processing tasks. In various examples of the present subject matter, different realizations of the block diagrams, circuits, and processes set forth herein may be created by one of skill in the art without departing from the scope of the present subject matter.

Machine (e.g., computer system) 500 may include a hardware processor 502 (e.g., a central processing unit (CPU), a graphics processing unit (GPU), a hardware processor core, or any combination thereof), a controller, a microcontroller, a microprocessor, a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 524 may further be transmitted or received over a communications network 526 using a transmission medium via the network interface device 520. The Machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include wired and/or wireless communications, such as Ethernet, Bluetooth, Bluetooth Low Energy, other Personal Area Networks (PANs), LoRa, NFC, Wi-Fi, WiMAX, 3G, 4G, LTE, 5G, the unlicensed 915 MHz Industrial, Scientific, and Medical (ISM) frequency band, ZigBee, among others. Some standards may support mesh networks. The networks include, but are not limited to, a local area network (LAN), a low-power wide-area network (LPWAN), a wide area network (WAN), a packet data network (e.g., the Internet), mobile telephone networks (e.g., cellular networks), Plain Old Telephone (POTS) networks, and wireless data networks, e.g., Institute of Electrical and Electronics Engineers (IEEE) 802.11 family of standards known as Wi-Fi®, IEEE 802.16 family of standards known as WiMax®, NFC, IEEE 802.15.4 family of standards, a Long Term Evolution (LTE) family of standards, a Universal Mobile Telecommunications System (UMTS) family of standards, peer-to-peer (P2P) networks, among others. The NFC circuitry may be embodied as relatively short-range, high frequency wireless communication circuitry and may implement standards such as ECMA-340/ISO/IEC 18092 and/or ECMA-352/ISO/IEC 21481 to communicate with other devices. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

### Other Notes and Examples

Example 1 is a method, including: monitoring, using a proportional, integral, and derivative (PID) controller, a dishwasher during operation of the dishwasher; detecting, using the PID controller, an error condition of the dishwasher using signals from one or more sensors; reporting, using a communication transceiver, failure information of the error condition; diagnosing, using the failure information and machine learning, a heating element component failure of the dishwasher; generating, based on the diagnosed component failure, service instructions for the component failure of the dishwasher; and displaying, for a user of the dishwasher, the service instructions including identifying information of replacement components for the dishwasher.

Example 2 is the method of Example 1, wherein monitoring the dishwasher during operation of the dishwasher includes remotely monitoring the dishwasher.

Example 3 is the method of Example 2, wherein remotely monitoring the dishwasher during operation of the dishwasher includes using a wireless connection.

Example 4 is the method of Example 2, wherein remotely monitoring the dishwasher during operation of the dishwasher includes using a wired connection.

Example 5 is the method of Example 1, wherein monitoring the dishwasher during operation of the dishwasher includes monitoring a heating element of the dishwasher.

Example 6 is the method of Example 1, wherein monitoring the dishwasher during operation of the dishwasher includes sensing limescale build up on a component of the dishwasher.

Example 7 is the method of Example 1, wherein monitoring the dishwasher during operation of the dishwasher includes sensing electrical current of the dishwasher.

Example 8 is the method of Example 1, wherein monitoring the dishwasher during operation of the dishwasher includes sensing electrical voltage of the dishwasher.

Example 9 is the method of Example 1, wherein monitoring the dishwasher during operation of the dishwasher includes sensing temperature of the dishwasher.

Example 10 is the method of Example 1, wherein reporting failure information of the error condition includes reporting failure information to a mobile device application.

Example 11 is the method of Example 1, wherein reporting failure information of the error condition includes reporting failure information to a cloud-based system.

Example 12 is a system, including: a computing system including one or more processors and a data storage system in communication with the one or more processors, wherein the data storage system includes instructions thereon that, when executed by the one or more processors, causes the one or more processors to: monitor, using a proportional, integral, and derivative (PID) controller, a dishwasher during operation of the dishwasher; detect, using the PID controller, an error condition of the dishwasher using signals from one or more sensors; report, using a communication transceiver, failure information of the error condition; diagnose, using the failure information and machine learning, a heating element component failure of the dishwasher; generate, based on the diagnosed component failure, service instructions for the component failure of the dishwasher; and display, for a user of the dishwasher, the service instructions including identifying information of replacement components for the dishwasher.

Example 13 is the system of Example 12, wherein the one or more processors include a processor of a mobile device.

Example 14 is the system of Example 12, wherein the one or more processors include a processor of a cloud-based system.

Example 15 is the system of Example 12, wherein the communication transceiver includes a Bluetooth communication transceiver.

Example 16 is the system of Example 12, wherein the communication transceiver includes a cellular communication transceiver.

Example 17 is the system of Example 12, wherein using machine learning includes using a machine learning model including a neural network.

Example 18 is the system of Example 12, wherein using machine learning includes using a machine learning model including a long short-term memory (LSTM) network.

Example 19 is the system of Example 12, wherein using machine learning includes using a machine learning model including an artificial intelligence (AI)-based knowledge tree.

Example 20 is the system of Example 12, wherein using machine learning includes using a machine learning model including a large language model (LLM).

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The foregoing examples are not intended to be an exhaustive or exclusive list of examples and variations of the present subject matter. The above description is intended to be illustrative, and not restrictive. Those of skill in the art will appreciate additional variations of the embodiments that can be used within the scope of the teachings set forth herein. The scope of the invention should be determined with reference to the appended claims, along with the full scope of equivalents to which such claims are entitled.

What is claimed is:

1. A method, comprising:
monitoring, using a proportional, integral, and derivative (PID) controller, a dishwasher during operation of the dishwasher;
detecting, using the PID controller, an error condition of the dishwasher using signals from one or more sensors;
reporting, using a communication transceiver, failure information of the error condition;
diagnosing, using the failure information and machine learning, a heating element component failure of the dishwasher;
generating, based on the diagnosed component failure, service instructions for the component failure of the dishwasher; and
displaying, for a user of the dishwasher, the service instructions including identifying information of replacement components for the dishwasher.

2. The method of claim 1, wherein monitoring the dishwasher during operation of the dishwasher includes remotely monitoring the dishwasher.

3. The method of claim 2, wherein remotely monitoring the dishwasher during operation of the dishwasher includes using a wireless connection.

4. The method of claim 2, wherein remotely monitoring the dishwasher during operation of the dishwasher includes using a wired connection.

5. The method of claim 1, wherein monitoring the dishwasher during operation of the dishwasher includes monitoring a heating element of the dishwasher.

6. The method of claim 1, wherein monitoring the dishwasher during operation of the dishwasher includes sensing limescale build up on a component of the dishwasher.

7. The method of claim 1, wherein monitoring the dishwasher during operation of the dishwasher includes sensing electrical current of the dishwasher.

8. The method of claim 1, wherein monitoring the dishwasher during operation of the dishwasher includes sensing electrical voltage of the dishwasher.

9. The method of claim 1, wherein monitoring the dishwasher during operation of the dishwasher includes sensing temperature of the dishwasher.

10. The method of claim 1, wherein reporting failure information of the error condition includes reporting failure information to a mobile device application.

11. The method of claim 1, wherein reporting failure information of the error condition includes reporting failure information to a cloud-based system.

12. A system, comprising:
a computing system comprising one or more processors and a data storage system in communication with the one or more processors, wherein the data storage system comprises instructions thereon that, when executed by the one or more processors, causes the one or more processors to:
monitor, using a proportional, integral, and derivative (PID) controller, a dishwasher during operation of the dishwasher;
detect, using the PID controller, an error condition of the dishwasher using signals from one or more sensors;
report, using a communication transceiver, failure information of the error condition;
diagnose, using the failure information and machine learning, a heating element component failure of the dishwasher;
generate, based on the diagnosed component failure, service instructions for the component failure of the dishwasher; and
display, for a user of the dishwasher, the service instructions including identifying information of replacement components for the dishwasher.

13. The system of claim 12, wherein the one or more processors include a processor of a mobile device.

14. The system of claim 12, wherein the one or more processors include a processor of a cloud-based system.

15. The system of claim 12, wherein the communication transceiver includes a Bluetooth communication transceiver.

16. The system of claim 12, wherein the communication transceiver includes a cellular communication transceiver.

17. The system of claim 12, wherein using machine learning includes using a machine learning model including a neural network.

18. The system of claim 12, wherein using machine learning includes using a machine learning model including a long short-term memory (LSTM) network.

19. The system of claim 12, wherein using machine learning includes using a machine learning model including an artificial intelligence (AI)-based knowledge tree.

20. The system of claim 12, wherein using machine learning includes using a machine learning model including a large language model (LLM).
